(19) United States
(12) Patent Application Publication
(10) Pub. No.: US 2005/0235281 A1
(43) Pub. Date: Oct. 20, 2005

(54) Combined software installation package

(75) Inventor: Claude Lefrancois, Laval (CA)

Correspondence Address: ALEX NICOLAESCU;Ericsson Canada Inc., Patent Department (LMC/M/P), 8400 Decarie Blvd., Town Mount Royal, QC, H4P 2N2, CA

(73) Assignee: Telefonaktiebolaget L M Ericsson (publ)

(21) Appl. No.: 10/826,396

(22) Filed: Apr. 19, 2004

(51) Int. Cl. G06F 9/445

(52) U.S. Cl. 717/175

(57) ABSTRACT

A method for creating a software installation package, a data storage medium storing the package, and a method for using the package are provided, wherein the package comprises an Operating System (OS) software program, an application program and possibly a configuration file of the application program. The package is created by inserting the application program in a partition data of the OS software program, and by generating the software installation package comprising the OS software program and the application program. Optionally, the package contains a configuration file inserted preferably in a memory disk image of an OS partition data of the OS software program. For using the package, a computer is started on a data storage medium storing the package, and the OS software program is installed on the computer from the data storage medium. Then, the application program is installed on the computer system, and optionally is configured with information from the configuration file.

### BACKGROUND OF THE INVENTION

1. Field of the Invention

The present invention relates to computer systems software installation packages.

2. Description of the Related Art

Computers and software are used for providing a variety of services, ranging from e-mail, Internet access, and file transfer to data processing, research, and communications. Telephone networks also use computer systems and software as communication nodes that allow the exchange of voice and data communications.

An operational computer system is typically composed of computer hardware that may include one or more motherboards, one or more processors, Random-Access Memory (RAM), Read-Only Memory (ROM), media storage such as one or more Hard-Disk Drives (HDD), etc, as it is well known in the art. An Operating System (OS) program typically runs on top of the computer hardware after being initially loaded into the computer and manages all the other programs. The other programs are called applications or application programs. The application programs make use of the OS by making requests for services through defined Application Program Interface(s) (API). An application program is any program that is designed to perform a specific function directly for the user or, in some cases, for another application program. Examples of application programs include word processors, database programs, Web browsers, development tools, drawing tools, paint tools, image editing programs, and communications programs. Application programs use the services of the computer's OS and possibly of other supporting programs.

Computer systems are prone to errors and malfunctions that may occur during their operation, such as for example a hardware failure (hard disk drive or random-access memory) or a major software fault. Some of these errors and malfunctions can result in the corruption of portions, or of the entire OS program, and can only be corrected through a complete reinstallation of the OS. In order to completely restore the service provided by such a failed computer system, the application program(s) also need to be reinstalled following the successful reinstallation of the OS. Finally, the newly reinstalled application program also needs to be re-configured using configuration information relative to its program state.

For example, if a malfunction occurs on an e-mail server and that this malfunction corrupts its OS, a network administrator would have to first, manually reinstall the OS, second, manually reinstall the appropriate e-mail application program, and third, manually reconfigure the e-mail application program with its configuration information (such as for example with the e-mail server identity, configuration parameters, user rights, etc.). System administrators therefore need to keep copies of OS installation programs, of the application programs installation packages, and as well prepare backup copies of configuration files, in order to be able to reinstall a failed computer system.

For example, the backup and restore procedure for the Ericsson-Juniper J20™ router involves the following steps:

Backup:

securing a copy of the OS installation programs;
securing a copy of the proper application program installation package;
stating in a configuration file the application program configuration;
   Restoring Following a Malfunction:
reinstalling the OS program using the OS installation program;
reinstalling the proper application program using the application program installation package;
configuring the application program with the information of the configuration file.

Each such step may include a plurality of sub-steps that are to be performed either in an automated or manual way. This type of procedure for restoring a computer system to its operational state is time-consuming since the system is re-installed from scratch. Most often, it requires the involvement of an experienced technical engineer who is skilled for running the procedure.

Reference is now made to FIG. 1 (Prior Art), which is an exemplary flowchart diagram representative of a prior art method for performing a restore of a failed computer system. In action 100, the OS is reinstalled and in action 102 a Local Area Network (LAN) connection is established with the computer system that needs to be reinstalled. The proper application program(s) is/are reinstalled through the newly established LAN connection in action 104 and, in action 10,6 the application program(s) is/are properly configured using, for example, configuration information that was previously stored in the configuration file. In action 108, the computer system is restarted and in action 110 its new configuration undergoes a checking and verification process to determine whether or not the new configuration is appropriate and reliable.

A similar procedure, which involves the separate and successive installation of an OS program, action 100, of an application program, action 104, as well as the configuration of the former, action 106, is also used for first-time installation of certain application programs, as shown in FIG. 1.

The existing procedures for backing up and restarting a computer system, as well as first-time installations, involve too many separate steps, most of which must be performed by humans, and are therefore prone to human errors. The presence of a skilled technician can minimize the occurrence of such errors, although it cannot completely eliminate them. However, the presence of skilled technician for restoring a computer system, or installing an OS and an application program, usually involves higher exploitation costs, and cannot be always guaranteed. The consequence is that i) with the existing restoring procedures, the down time of failed computer systems can be extended, and this results in a downgrade of the quality of service provided by a particular service and ii) the cost of first-time installation procedures is increased.

Although there is no prior art solution as the one proposed hereinafter for solving the above-mentioned deficiencies, the Patent Application Publication WO 03/083658 bears some relation with the field of the present invention. This publication teaches a storage backup and filter module which is utilized in order to restore a storage device and make it bootable. The module makes a shadow storage device invisible to a BIOS and to an OS. The module stores a storage device image of the storage device to a shadow storage device, and restores at least one section of the storage device image from the shadow storage device to the storage device. In this publication, when a malfunction occurs, a backup storage device restores the storage device image from the shadow storage device on to the storage device itself.

However, the patent application Publication WO 03/083658 fails to address the issue of restoring or installing an OS program, a software application and its configuration information in an optimized and efficient fashion as proposed herein.

Accordingly, it should be readily appreciated that in order to overcome the deficiencies and shortcomings of the existing solutions, it would be advantageous to have a method and system for efficiently backing up and restoring a computer system, or for first-time installations of an OS and application program, by minimizing the steps required for installing the OS, the appropriate software application program and its configuration information. The present invention provides such a solution.

### SUMMARY OF THE INVENTION

In one aspect, the present invention is a method for creating a software 2 0 installation package for an installation of an Operating System (OS) software program and of an application program on a computer system, the method comprising the steps of:
a) inserting the application program in a partition data of the OS software program; and
b) generating the software installation package comprising both the OS software program and the application program.

In another aspect, the present invention is a data storage medium comprising a software installation package for an installation of an Operating System (OS) software program and of an application program on a computer system, wherein the software installation package comprises the OS software program and the application program, and wherein the application program is stored in a partition data of the OS software program.

In yet another aspect, the present invention is a method for using a software installation package for an installation of an Operating System (OS) and of an application program on a computer system, the method comprising the steps of:
a) starting the computer system on a data storage medium that stores a software installation package for an installation of an OS software program and of an application program, wherein the software installation package comprises the OS software program and the application program, and wherein the application program is stored in a partition data of the OS software program;
b) installing the OS software program on the computer system from the data storage medium; and
c) installing the application program on the computer system from the data storage medium.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is an exemplary flowchart diagram representative of a prior art method for performing a restore of a failed computer system or a first-time installation of an OS and application program;

FIG. 2 is an exemplary flowchart diagram representative of a method for creating a software installation package to be used for a first-time installation or a reinstallation of a computer system according to the preferred embodiment of the present invention;

FIG. 3 is an exemplary schematic representation of the changes in the data structure of the software installation package according to the preferred embodiment of the present invention;

FIG. 4 is an exemplary schematic representation of the final software installation package according to the preferred embodiment of the present invention; and

FIG. 5 is an exemplary flowchart diagram of a method for installing or reinstalling an OS and an application program using the software installation package of the present invention.

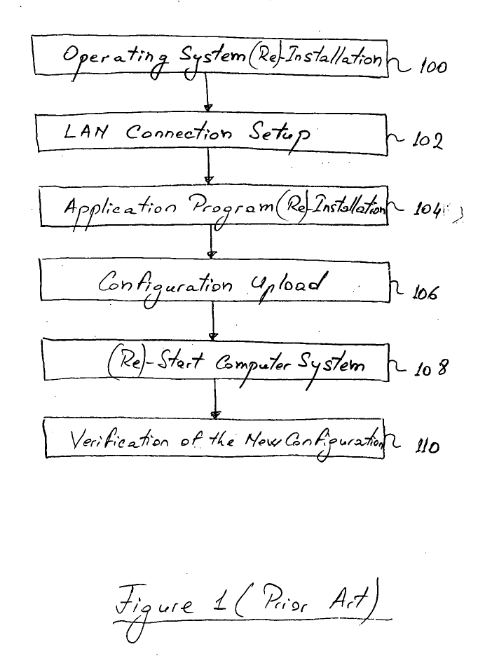

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

In order to better understand the present invention, an explanation of the terminology used herein is required. In the context the description of the preferred embodiment of the invention, the following terminology is used:
Master Boot Record (MBR): small program executed when a computer system boots up. Typically, the MBR resides on the first sector of the physical storage media. The program begins the boot process by looking up the partition table to determine which partition to use for booting (active partition). It then transfers program control to the boot sector of that partition, which continues the boot process.
Boot Sector: Area of a physical storage media containing instructions enabling a computer system to launch an operating system. These instructions are executed every time the computer starts up.
Partition table: summary of all the available partitions located on a physical media storage. The partition table keeps track of the active partition, which is unique and used to boot the computer system.
OS Partition data: a section of the main memory or physical mass storage media that has been reserved for a particular application.
Memory Disk Image: the exact copy of a computer system physical storage media. The copy includes all the partition information, boot sectors, the file allocation table, operating system installation and application software. Memory disk images are often used during operating system installation. Specific tasks are performed from a storage media through different applications during such software installation process. Since the physical hard disk of a computer cannot be used because this storage media is the target of the operating system installation process, a virtual media is created into the memory of the computer (RAM) and the memory disk image is copied to this virtual media in order to provide the operating system installation process a storage media.

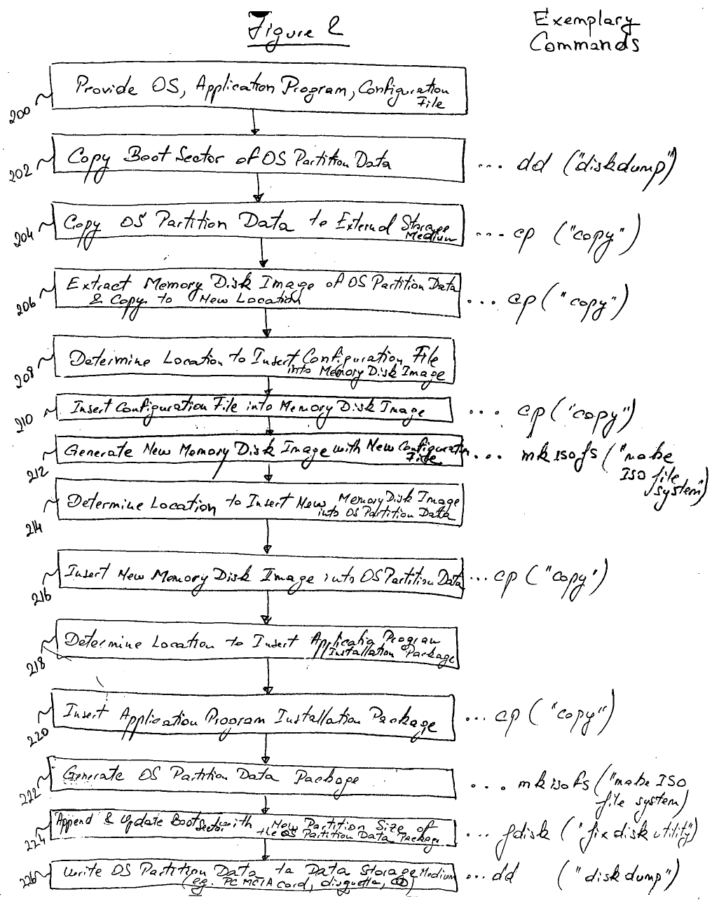

Reference is now made to FIG. 2, which is an exemplary flowchart diagram representative of a method for creating a software installation package to be used for a first-time installation or a reinstallation of both an Operating System (OS) program and of an application program according to the preferred embodiment of the present invention. According to the preferred embodiment of the present invention, the software installation package not only comprises the relevant Operating System (OS), but also the relevant software application program(s), and a configuration file that stores configuration parameters relative to the application program(s). The configuration file may, for example, store networking, services, security and host parameters.

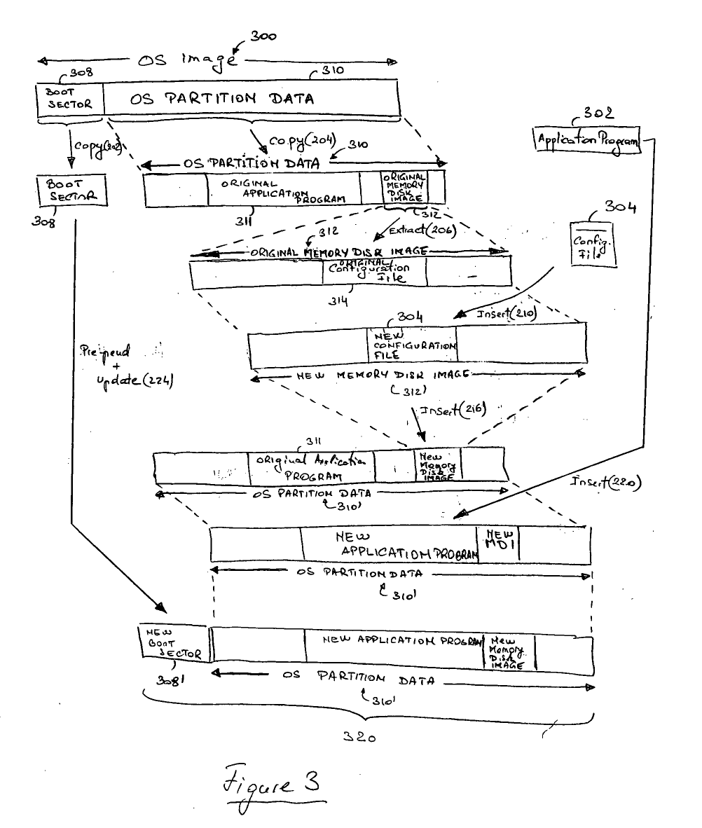

Reference is also made to FIG. 3, which is an exemplary schematic representation of the changes in the data structure of the software installation package during its creation according to the preferred embodiment of the present invention.

With reference being now jointly made to FIG. 2 and FIG. 3, in order to create a software installation package that combines the OS, the application program and the configuration of the application program, first, in action 200, there are provided the relevant OS 300, application program 302 and configuration file 304 as stand-alone entities. For example, the OS 300 may be provided as an OS installation file or package on a data medium support (e.g. CD or floppy-disk) manufactured by a company. An example of such an OS installation file may be, for example, the Solaris™ OS manufactured by Sun Inc. The OS 300 typically takes the form of a data file comprising first, a master boot record that contains a program that starts the computer, second a boot sector portion 308 that stores instructions to start the OS and, third, an OS partition data portion 310. The application program 302 may also be provided as an installation package, such as for example the MS Office™ application program manufactured by Microsoft Corp, while the configuration file 304 may take various formats as required by the particular application program 302. In action 202, the boot sector portion 308 of the OS installation file 300, including the master boot record, is copied from the installation file 300 to another location, such as for example to a host computer system hard disk, using for example a “disk dump” (“dd”) UNIX command. Further, in action 204, the content of the OS partition data portion 310 is also copied to another location, such as for example to the host computer system hard disk, using for example a “copy” (“cp”) UNIX command. The OS partition data portion 310 may optionally comprise an original application program 311, and an original memory disk image 312, which is a data portion that stores the OS installation software. In action 206, the memory disk image 312 is extracted from the OS partition data portion 310, and its content copied to another location, using for example the UNIX “copy” command. The copied memory disk image content 312 may optionally comprise an original configuration file 314 that stores original (default) configuration parameters associated with the original application program 311. Typically, the original configuration parameters are basic or default parameters that may configure the application program for a default type of service. In action 208, it is optionally determined the proper location where to insert the new configuration file 304 that stores the new parameters for the new application program 302 into the memory disk image 312. Action 208 may comprise the determination of the location of the original configuration file 314 within the OS partition data 310, or any other steps necessary to find out the proper location within the memory disk image 312 where the new configuration file 304 is to be stored. For example, in some implementations, no original configuration file 314 may exist within the OS partition data 310, and in such instances, action 208 may comprise an analysis and determination process of the OS partition data 310 in order to determine the proper location to insert the configuration file 304. Further, in action 210, the new configuration file 304 is inserted at the proper location in the memory disk image, which action may, for example, include the copy of the new configuration file 304 to the determined location over the original configuration file 314, which it thus replaces. At this point, the updated memory disk image 312′ comprises the new configuration file 304. In action 212, a new memory disk image containing the new configuration file 304 is generated, such as for example using the UNIX “make ISO file system” (“mkisofs”) command. In action 214, it is further optionally determined the proper location to insert the newly created memory disk image 312′ into the OS partition data 310. Action 214 may comprise the determination of the location of the original memory disk image 312 within the OS partition data 310, thus allowing for a copy command to be executed in order to replace the original memory disk image 312 with the newly created memory disk image 312′ that contains the new configuration file 304. In action 216, the new memory disk image 312′ is inserted into the OS partition data 310, for example using the UNIX “copy” command, thus creating a new OS partition data 310′ that contains the original application program 311, but also comprises the new memory disk image 312′. In action 218, it is optionally determined the proper location to insert the new application program 302 into the OS partition data 310′, which action may comprise determining the location of the original application program 311 within the OS partition data 310′. Further, in action 220, the application program 302 is inserted into the OS partition data 310′, for example using the UNIX “copy” command. In action 222, a new OS partition data package is generated using for example, the UNIX “mkisofs” command, and in action 224, the boot sector 308 is appended to the new OS partition data 310′, and is updated with the new partition size of the new OS partition data 310′ that reflects the change of the size of the OS partition data 310′ with respect to the original OS partition data 310. The different size of the new OS partition data 310′ may have its source in the different size of the new configuration file 304 that is typically different than the one of the original configuration file 314, since it typically comprises additional configuration parameters. Action 224 may comprise the use of the UNIX “fixed disk utility command” (“fdisk”). Finally, in action 226 the newly created software installation package 320 that comprises the updated boot sector 308′ as well as the new OS partition data 310′ is copied on a data repository, such as for example on a PCMCIA card, a floppy-disk, or a CD, which may be used for (re)starting (booting or rebooting) the computer system following a crash or malfunction, or during a first-time installation procedure.

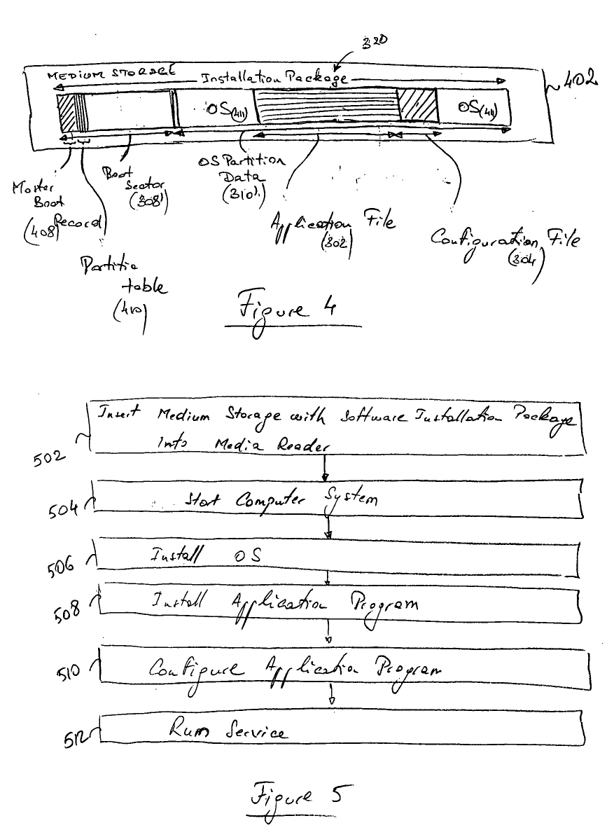

Reference is now made to FIG. 4, which is an exemplary schematic representation of the software installation package 320 according to the preferred embodiment of the present invention. Following its creation described hereinbefore in FIGS. 2 and 3, the software installation package 320 may be copied and stored on various medium storage devices 402, such as for example on a PCMCIA card, a compact flash card, a floppy disk, a Compact Disk (CD), etc, which may be inserted into a computer system for installation or re-installation purposes. The installation package 320 comprises the boot sector 308′ and the OS partition data portion 310′. The boot sector 308′ comprises a master boot record 408 comprising a program to start the computer system and a partition table 410 that comprises a list of all the partitions found on the mass storage media and comprises initial instructions to start the OS. On the other hand, the OS partition data 310′ comprise a first portion 411 storing the OS software, a second portion storing the application program installation file 302 and a third portion storing the configuration file 304.

Therefore, with the present invention it becomes possible to merge into one single software installation package 320 an OS installation package, an application program installation package, and a configuration file that stores configuration parameters for configuring the application program according to specific needs.

Reference is now made to FIG. 5, which is an exemplary flowchart diagram representative of a method for installing or a restoring (reinstalling) a service provided by a computer system using the software installation package provided by the preferred embodiment of the present invention. With reference being now jointly made to FIG. 4 and FIG. 5, in action 502, the media storage device containing the software installation package 320 is inserted into a proper media reader of the computer system, such as for example into a CD reader, a PCMCIA card reader or a disquette reader of the computer system depending on the type of the media storage device itself, and in action 504 the computer system is started (or re-started). In action 506, the computer system boots and reads the medium storage device using the media reader and installs the OS. Further, in action 508, the computer system reads the application program file 302 and performs the installation of the application program. Finally, in action 510, the computer system reads the configuration file 304 and configures the application program 302 based on the configuration parameters stored in the configuration file 304. Having installed the OS and the application program, and further having already configured the application program 302 with the proper configuration parameters, in action 512 the service provided by the application program is started and can be adequately run.

Based upon the foregoing, it should now be apparent to those of ordinary skills in the art that the present invention provides an advantageous solution, which offers an optimized and efficient software installation procedure of both an OS and application program configured with particular configuration parameters. Although the system and method of the present invention have been described in particular reference to the satisfaction of the need of re-installation of a service following a computer system failure, it should be realized upon reference hereto that the innovative teachings contained herein are not necessarily limited thereto and that the software installation package provided herein can also be used for first-time software installations, or for regular installations that are not preceded by a computer failure or malfunction. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for creating a software installation package for an installation of an Operating System (OS) software program and of an application program on a computer system, the method comprising the steps of:
a) inserting the application program in a partition data of the OS software program; and
b) generating the software installation package comprising both the OS software program and the application program.

2. The method of claim 1, further comprising prior to step a) the step of:
c) determining a location in the partition data of the OS software program where to insert the application program.

3. The method of claim 1, further comprising prior to step b) the steps of:
c) inserting a configuration file of the application program in the partition data of the OS software program.

4. The method of claim 3, further comprising prior to step c) the step of:
d) determining a second location in the partition data of the OS software program where to insert the configuration file of the application program.

5. The method of claim 4, wherein:
step d) comprises the step of:
d.1) identifying a memory disk image in the OS partition data;
step c) comprises the step of:
c.1) inserting the configuration file of the application program in the memory disk image of the partition data of the OS software program.

6. The method of claim 3, further comprising prior to step b) the step of:
c) updating a boot sector of the OS partition data of the OS software program to reflect a size of the OS software program following the insertion of the configuration file.

7. The method of claim 1, further comprising, subsequent to step b), the step of:
storing the software installation package on a data storage medium.

8. The method claimed in claim 7, wherein the data storage medium is a data storage medium selected from the group of data storage media consisting of: a floppy disk, a compact flash card, a PCMCIA card, and a Compact Disk (CD).

9. A data storage medium comprising a software installation package for an installation of an Operating System (OS) software program and of an application program on a computer system, wherein the software installation package comprises the OS software program and the application program, and wherein the application program is stored in a partition data of the OS software program.

10. The data storage medium of claim 9, wherein the OS software program further comprises a configuration file of the application program.

11. The data storage medium of claim 10, wherein the configuration file is stored in a memory disk image of the partition data of the OS software program

12. The data storage medium claimed in claim 9, wherein the data storage medium is a data storage medium selected from the group of data storage media consisting of: a floppy disk, a compact flash card, a PCMCIA card, and a Compact Disk (CD).

13. A method for using a software installation package for an installation of an Operating System (OS) and of an application program on a computer system, the method comprising the steps of:
a) starting the computer system on a data storage medium that stores a software installation package for an installation of an OS software program and of an application program, wherein the software installation package comprises the OS software program and the application program, and wherein the application program is stored in a partition data of the OS software program;
b) installing the OS software program on the computer system from the data storage medium; and
c) installing the application program on the computer system from the data storage medium.

14. The method of claim 13, wherein the OS software program further comprises a configuration file of the application program.

15. The method of claim 14, wherein the configuration file is stored in a memory disk image of the partition data of the OS software program.

16. The method claimed in claim 13, further comprising the steps of:
d) configuring the application program using information from the configuration file.

17. The method claimed in claim 13, wherein the data storage medium is a data storage medium selected from the group of data storage media consisting of: a floppy disk, a compact flash card, a PCMCIA card, and a Compact Disk (CD).
